(19) United States
(12) Patent Application Publication
(10) Pub. No.: US 2025/0314015 A1
(43) Pub. Date: Oct. 9, 2025

(54) A MARINE BIODEGRADABLE AND RECYCLABLE PAPER-BASED PACKAGING MATERIAL WITH HIGH MOISTURE AND OXYGEN BARRIER PROPERTIES

(71) Applicant: Société des Produits Nestlé S.A., Vevey (CH)

(72) Inventors: Michael Karlheinz Hausmann, Boudry (CH); Abhijit Bhattacharya, Epalinges (CH); Johannes Zimmer, Lausanne (CH); Martin Haeri, Lausanne (CH); Hannah Kleyer, Lausanne (CH); Lise Zeboudj, Neuvecelle (FR); Jenni Irina Jukarainen, Pully (CH)

(73) Assignee: Société des Produits Nestlé S.A., Vevey (CH)

(21) Appl. No.: 18/865,865

(22) PCT Filed: May 15, 2023
(86) PCT No.: PCT/EP2023/063016

§ 371 Date: Nov. 14, 2024

(30) Foreign Application Priority Data
May 16, 2022 (EP) 22173646.5

(51) Int. Cl. D21H 19/82; B65D 65/42; B65D 65/46; D21H 19/08; D21H 19/28; D21H 19/34; D21H 19/60; D21H 19/64; D21H 27/10; D21H 27/30

(52) U.S. Cl. CPC D21H 19/828; B65D 65/42; B65D 65/466; D21H 19/08; D21H 19/28; D21H 19/34; D21H 19/60; D21H 19/64; D21H 27/10; D21H 27/30

(57) ABSTRACT

The present invention is directed to a marine biodegradable and recyclable multi-layer metallized paper-based packaging material comprising a layered arrangement of superimposed organic and inorganic materials for providing barrier to oxygen and moisture: the organic and inorganic layers are made of materials which are selected for their marine biodegradable properties. In one embodiment of the present invention the multi-layer metallized paper-based packaging material can be recycled with other paper packaging materials.

### FIELD OF THE INVENTION

The present invention relates to a marine biodegradable multi-layer paper-based packaging material comprising a paper layer, an ultrathin metal or metalloid layer for water vapour barrier that is sandwiched between marine biodegradable polymeric thin layers that provide oxygen barrier and sealability to the structure. The resulting packaging material is marine biodegradable as well as recyclable in paper recycling stream, while at the same time providing excellent barrier properties to the packaged product against moisture and oxygen.

### BACKGROUND OF THE INVENTION

Plastic packaging is used frequently in the economy and in people's daily lives. It has multiple advantages, such as its flexibility and its light weight. Such a weight reduction contributes to fuel saving and CO₂ reduction during transport, for example. Its barrier properties help to reduce food waste due a positive effect on increasing shelf life. The barrier properties also help to secure food safety.

However, with increasing environmental awareness, and in order to ensure that plastic waste is reduced, multilayer packaging materials have been developed which include a paper layer, and one or several layers of plastic or metal films, which provide robustness as well as barrier properties, especially to oxygen and moisture.

In the most recent years, environmental awareness increased even further, in particular in relation to waste materials, for instance used packages, that are not recycled or treated properly, and contaminate oceans. This challenge is considered very seriously by industrials who spend increasingly extensive efforts to develop new packaging materials that are rapidly and easily biodegradable if accidentally thrown in nature, and in particular in a marine environment.

When manufacturing multilayer packaging material structures today, applying a layer of plastic by known techniques, in particular extrusion (extrusion-lamination), or similarly by an adhesive lamination process, necessarily provides a high thickness of the plastic film thus obtained onto the paper.

Even for relatively low thicknesses of extruded polymers in multilayer structures as described above, the cohesive strength of the polymer film is very high and the level of adhesion of the polymer to the paper or cardboard (i.e. cellulosic) substrate is also high. This prevents such polymer to detach from the substrate when recycled and prevents recycling and repulping of the cellulosic fiber portion in a paper-stream recycling process.

Therefore, later during the recycling process, the multilayer structure comprising a mixture of paper and plastic (polymer) films either extruded (by classic techniques as extrusion-lamination or extrusion coating) or adhesive-laminated, cannot be recycled in a paper-stream recycling process because the plastic layer is too thick to be dispersed and at the same time the same layer has cohesion strength and adhesion level to the adjacent layers of the structure, which are way too high to be separated from the other layers of materials, especially from the paper fibres. The extruded plastic film remains intact within the paper pulp bath, hence making it difficult to recycle paper pulp from the repulping process.

More than that, the recycling process of known laminated materials described above is expensive, and energy consuming and characterized with relatively low yield of paper fibres that are recycled (around 60% from the total amount of packaging materials in the entire structure), hence, not sufficiently environmentally friendly from a disposal and recycling perspective. There is also room for improving the recyclability of the rest of the packaging material (i.e. the plastic polymer and the metal parts, e.g. aluminium parts) in a paper recycling stream.

Furthermore, for packaging intended for food products, good barrier properties are essential for maintaining the safety and quality of packaged foods. Typically, such barrier properties include gas barrier, for example to oxygen and water vapor (moisture), and if possible, also, liquid tightness.

One way to provide good moisture barrier in paper-based packaging materials, is the introduction of a metal or metalloid layer in a so-called “metallized” layer. In the present description, the word “metallized” (for instance in the expression “metallized barrier paper layer”) is meant to encompass the deposition at the surface of paper or paperboard, of metal or metalloid atoms. One can even consider embodiments comprising the deposition of an alloy of metal and metalloid. Metalloids are close to metals in some of their characteristics. Aluminium oxide and silicon oxide are examples of metalloids.

As said above, the current trend is to move from plastic to paper-based packaging materials. However, paper as such is very sensitive to moisture and provides very little protection to the product packed in a package made therefrom. Furthermore, for economic reasons, it is favourable that the paper material can run on the same production lines as for conventional multi or mono layered plastic: this avoids new investments in production machine that would negatively impact the cost of packages thus produced. However, because of the poor resilience of paper, it is very difficult to process it on itself: because paper is hygroscopic—and does not provide a proper barrier against oxygen and moisture—there is a need to add additional materials to achieve a final structure that meets the necessary properties (mechanical strength, resilience, sealability and barrier) that are required for packaging, especially for food packaging.

In order to provide the required resilience and barrier properties, paper is usually coated (dispersion coating, extrusion coating, rotogravure and so on) with various polymer layers. Additionally, moisture barrier can be greatly improved by adding a metallization layer within the structure.

Most of the paper-containing multilayer structures currently explored for packaging purposes, contain oil-based organic materials that are not biodegradable. Additionally, if the multilayer structure is not well designed, the metallization layer is damaged during the conversion into the final packaging and any high barrier properties of the flat multilayer structure are lost after processing of the latter into a formed, filled and sealed package, which is of course undesirable.

Furthermore, in order to be accepted into paper recycling stream processes, packages have to contain at least 80 to 95% paper (depending on local regulations) in relation to the whole structure. However, despite the sustained efforts of industrials to innovate and develop paper-based environmentally friendly packaging, many countries in the world are still not yet fully ready with infrastructures and recycling facilities suitable for recycling used paper-based packages.

Furthermore, despite increasing communication and awareness campaigns for educating consumers and local governments, a certain proportion of packages still contaminate rivers and oceans, which is a major concern.

Having considered the above, there is a need for a biobased multi-layered packaging structure that is fully bio-degradable in marine conditions. Additionally, there is a need for a packaging structure that features all following key points:
high barrier properties to oxygen and water vapour (moisture),
a high resilience to mechanical stress, such that it keeps the same level of barrier even when subjected to transformation processes such as the ones used for manufacturing packages,
a greatly reduced amount of plastic polymer contents compared to the content of cellulosic material,
interlayer adhesion to provide high mechanical resistance (especially stiffness) to the structure and packaging made thereof.

### SUMMARY OF THE INVENTION

The objective of the present invention is achieved with a marine biodegradable multi-layer metallized paper-based packaging material comprising, from its outer side to its inner side:
a paper layer having a grammage comprised in the range of 30 to 120 g/m²,
at least one first organic layer comprising at least one polymer being marine biodegradable according to standards ISO 22403:2020 or its equivalent ASTM D6691:2017, said at least one polymer being selected within the list of: a polyhydroxyalcanoate (PHA), a microfibrillated or nanofibrillated cellulose, a polyglycolide (PGA), or a combination thereof, said at least one polymer being applied as a layer in an amount of 0.5 to 15 g/m², preferably in an amount of 1 to 7 g/m², said biodegradable polymer having a melting temperature comprised between 160° C. and 200°° C., preferably between 170° C. and 180° C.,
a vacuum deposited or transfer-metallized inorganic layer, comprising a metal, a metalloid, or a combination thereof, said inorganic layer having a thickness comprised between 1 and 100 nm, and
at least one second organic layer comprising at least one polymer being marine biodegradable according to standards ISO 22403:2020 or its equivalent ASTM D6691: 2017, said at least one polymer being selected within the list of: a polyhydroxyalcanoate (PHA), a polycaprolactone (PCL), or a combination thereof, said at least one polymer being applied in an amount between 0.5 and 30 g/m², preferably in an amount between 1 to 10 g/m², said biodegradable polymer having a melting temperature comprised between 30° C. and 160° C.

By “transfer-metallized” it is meant that an ultrathin layer of metal or metalloid material is deposited onto a support film, which is then placed in contact with the destination medium, such that the metal or metalloid layer is transferred to said destination medium. Transfer metallization is known in the art and will not be described in further details therein.

All the components of the packaging material are certified for marine biodegradability according to the principle of the invention.

In one possible but optional embodiment, polyvinylalcohol (PVOH), ethylene vinyl alcohol (EVOH), butenediol vinyl alcohol (BVOH), poly (butylene succinate-co-butylene adipate (PBSA), polybutylene adipate terephthalate (PBAT), polyhydroxyalcanoates (PHA) or copolymers or compounds thereof, can be added in extremely low quantities as part of the first organic layer, or as part of the innermost layer (heat seal layer). These polymers are not marine biodegradable as such except in very small quantities, that do not exceed 1% of the total weight of the material, or maximum 20% in weight of the other organic marine degradable materials. For instance PBSA or PBAT can be blended with PHA in the heat seal layer in an amount that does not exceed 20% of PBSA or PBAT for 80% of PHA. The total contents of such polymers which are not as such marine biodegradable should however not exceed a maximum amount such that the overall structure still remains marine biodegradable. These compounds were found to improve adherence between layers and processability. They are only optional.

Marine biodegradability can be certified according to e.g. international standards ISO 22403:2020, or its equivalent ASTM D6691:2017, and through independent testing laboratories like TÜV Austria. More specifically, ISO 18830 and ISO 19679, for example, are two standards on the test methods for determining the aerobic biodegradation of non-floating plastic materials at the seawater/sediment interface, and are applicable to certifying materials used in the structure according to the invention, and/or the finished product.

The overall thickness of polymer coating layers in the structure is extremely reduced compared to the thickness of paper material, therefore the inventors have achieved to overcome the technical limitations of the known multilayer barrier structures, and achieve a packaging multilayer structure with excellent barrier properties against oxygen and moisture transfer, as well as resistance to liquid contact from their inner or outer surfaces, while achieving a total contents of cellulosic fibres comprised preferably up to 90% of the overall material weight.

The fact that the inventors succeeded in forming a multilayer structure completely deprived of polymer layers formed by extrusion lamination and/or adhesive lamination, provides a multilayer structure with a ratio of cellulosic fibre to non-cellulosic material, which is extremely high in fibre contents, and wherein the polymer layers are easy to separate in repulping process due to the solubility of the precoating layer in water, and also the relatively low adhesion of the post-metallization (or post-metalloidization) polymer to the rest of the metallized layer. The resulting structure therefore demonstrates excellent repulping capabilities and high fibre yield which allows it to be accepted in paper waste collection in the most countries. The very low content of non-cellulosic polymer and vacuum-deposited metal materials, makes the whole material of the invention easily disintegrated, dissolved and separated during recycling processes designed for cellulosic materials like paper or cardboard, unlike existing multi-layer barrier structures known from the art.

Preferably, the biodegradable polymer of said second organic layer has a tensile strength above 30 MPa and elongation at break above 850%.

Furthermore, at least one polymer of said first and/or second organic layer(s) is preferably functionalized by grafting with maleic anhydride. Alternatively or simultaneously, at least one polymer of said first and/or second organic layer(s) can be plasma activated.

Advantageously, the polyhydroxyalcanoate (PHA) of said at least one second organic layer can be compounded with hardwood cellulose fibres, such that said compound comprises at least 50% of cellulose fibres.

In possible embodiments of the invention, the first organic layer optionally further comprises a mineral filler selected within the list of: kaolin, calcium carbonate, talc, silica, wollastonite, clay, calcium sulfate fibers (also known as Franklin fiber), mica, glass beads, alumina trihydrate, and combinations thereof.

Preferably, the metal or metalloid inorganic layer is selected within the list of: aluminium, aluminium oxide (AlOx), silicon oxide (SiOx), or an alloy thereof.

Advantageously, the marine biodegradable packaging material of the invention can further comprise an organic barrier layer coated between the first organic layer and the inorganic layer, said barrier layer comprising polyglycolide (PGA) polymer, or a cellulose fiber (nano- or microfibrillated) layer, in an amount in the range of 0.5-30 g/m², preferably in the range of 1 to 15 g/m².

The organic layers can be applied either as an aqueous solution or dispersion, or by extrusion of an ultrathin layer having a thickness lower than 30 g/m², preferably lower than 15 g/m².

Furthermore, in addition to its intrinsic marine biodegradability properties, thanks to the carefully selected organic and inorganic components, the packaging material of the invention was also found to be recyclable as paper and/or carton in dedicated paper/carton recycling stream processes, in most countries, due also to its higher cellulosic contents.

Last but not least, the packaging material according to the invention is not only marine biodegradable by structure, but it also preferably features a Water Vapour Transmission Rate (WVTR) below 1 g/m²/day (measured at 23° C., 85% Relative Humidity) and/or an Oxygen Transmission Rate (OTR) below 1 cm³/m²/day bar (measured at 23° C., 50% RH).

Further, this material has preferably a strain at break under in-plane tensile loading up to 4% in machine direction and up to 10% in the cross-machine direction of the paper.

The present invention is further directed to a tridimensional closed packaging item made of a marine biodegradable multi-layer metallized paper-based packaging material as described above, which is obtained by forming, filling with an edible product for human or animal consumption, and then sealing said packaging material.

The present invention is also directed to a marine biodegradable multi-layer metallized paper-based packaging material as described above, for packing an edible product for human or animal consumption.

Finally, the present invention is also directed to a packaged edible product, comprising a marine biodegradable multi-layer metallized paper-based packaging material as described above, filled with an edible product for food or animal consumption.

As used in this specification, the words “comprises”, “comprising”, and similar words, are not to be interpreted in an exclusive or exhaustive sense. In other words, they are intended to mean “including, but not limited to”.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 shows a first embodiment of a multilayer structure according to the invention;

FIG. 2 shows a second embodiment of a multilayer structure according to the invention.

### DETAILED DESCRIPTION OF THE INVENTION

Generally, in the present specification, “extrusion coating”, it is meant a method to provide a layer of polymer by using an extruder which forces melted thermoplastic resin (e.g. polyethylene) through a horizontal slot-die onto a moving web of substrate (e.g. paper). The resulting product is a permanently coated web structure.

By “extrusion lamination”, it is meant a similar process to extrusion coating, whereby a polymer resin is extruded between two substrates (e.g. a layer of paper and another layer of polymeric film), and acts as a bonding agent.

By “adhesive lamination”, it is meant a process whereby one paper material is coated with adhesive and laminated to a second paper or paperboard material.

In a lamination process, two thick layers of material are combined, either by extrusive lamination or adhesive lamination, whereby the thickness of each layer is far greater than the thickness obtained by dispersion coating.

By “dispersion coating”, it is meant a coating technique whereby an aqueous dispersion of fine polymer particles or polymer solution is applied to the surface of paper or board as such, in order to form a solid, non-porous film after drying. Dispersion coating can be performed by gravure, flexo-gravure, rod, blade, slot-die, curtain air knife, or any other known method of paper coating. Dispersion coating can create a much thinner layer than extrusion lamination and/or adhesive lamination, since the polymer is mixed in an aqueous water solution. This brings advantages in terms of quantity of polymer usage, its barrier performance and recyclability of resulting paper structure. The target of dispersion coating is to achieve a barrier layer against water, water vapour, grease, oil, gas, etc. by environmentally friendly coating. Another target is to prepare surface of paper material for a vacuum deposition process.

By “plasma activation” it is meant that the adhesion between two adjacent layers of the structure can be improved, by submitting the surface of at least one of the two layers to a process by which polymer functional groups are replaced with different atoms by ionisation in a plasma. As a result, the surface energy of the plasma-activated layer is generally increased. Alternatively, plasma activation can: add bonds with other chemicals, degrade or break bonds, or cross-link material.

In all possible embodiments of the invention, and especially in the exemplary embodiments described specifically hereafter, the multilayer packaging structure is biodegradable in a marine environment. Such a biodegradability is achieved when the structure contains a cellulosic base, an ultrathin inorganic layer that contains only a few atoms of metal or metalloid per square meter, and also because all organic components are marine biodegradable polymers.

Biodegradability of the final structure is defined and tested under international standards mentioned above, especially ISO 22403:2020, or its equivalent ASTM D6691:2017.

In addition to, or alternatively to, its intrinsic biodegradability properties, the multilayer structure according to the invention is also preferably designed to qualify for being as well recyclable in a paper stream process.

Recyclability in the paper stream is achieved by multilayer structure of the invention wherein:
cellulose contents is predominant relatively to all the ingredients contained therein (the definition of recyclability in the paper stream depends on national legislations but in order to be accepted in a recycling process dedicated to paper in the highest number of countries, a material should contain at least 80% cellulose, preferably at least 90% cellulose), and
the inorganic layer is ultrathin (i.e. a few nanometres, typically between 1 and 50 nm) and its thickness is constituted of a few atoms,
organic polymer layers are preferably deposited by coating or thin-layer extrusion, which means that the layers thus obtained are sufficiently thin in relation to paper thickness to achieve an extremely high paper contents of the overall structure,
and finally, the subsequent organic layers (second organic layer, third, etc.), that are deposited on the inner side of the metallic or metalloid layer, feature low cohesion and low adhesion with the rest of the structure components, which makes the whole structure compatible with paper recycling processes as explained herein before.

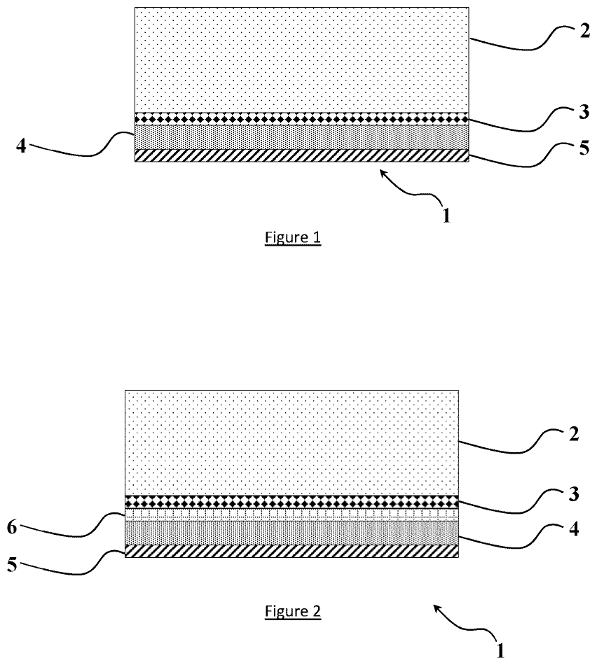

In FIG. 1 is illustrated a first embodiment of the invention. In this embodiment, the multilayer structure 1 comprises in order, from its outer side towards its inner side (i.e. the inner side in contact with the packaged product):
a highly smooth paper layer 2 of grammage 62 g/m²,
a first organic polyglycolide (PGA) pre-metallization coating layer 3 that provides mainly gas (esp. oxygen) barrier properties and is applied as an aqueous solution in weight of 3 g/m²,
an inorganic vacuum deposited layer 4 of aluminium having a thickness of 40 nm, which provides mainly moisture vapour barrier properties, and
a second organic coating layer 5 of polycaprolactone (PCL) that is applied as an aqueous dispersion in weight of 5 g/m².

The innermost polycaprolactone layer 5 functions as a heat sealable layer in this first embodiment.

The inorganic layer 4 of aluminium can be deposited by a direct metallization process, or by a transfer metallization process.

In this embodiment, the first and second organic layers are applied by aqueous dispersion coating technique, which allows to improve their recyclability in a paper stream process.

The structure 1 of this first embodiment achieves high moisture and gas barrier properties with values of Oxygen Transmission Rate (OTR) below 1 cm³/m²/day measured at 23° C. and 50% relative humidity (RH), and water vapour transmission rate (WVTR) below 1 g/m²/day measured at 23° C. and 85% RH.

The tensile strength of the polycaprolactone polymer used for the PCL layer 5, is measured in standard test conditions (DIN EN ISO 527-1) at 33 MPa, and its elongation at break is measured at 910%. These values provide excellent resilience properties which allow to protect the aluminium layer during processing of the structure in conventional packaging forming processes. No cracking of the aluminium layer is generated during bending, stretching and/or sealing of the material when manufacturing a package out of it, which results in maintaining the level of OTR and WVTR barrier properties equivalent before and after a package is formed from the multilayer structure material.

As an alternative in this first embodiment, the innermost PCL dispersion coating heat-seal layer can be replaced by a protein-based heat seal layer (e.g. casein), or a polyhydroxyalcanoate (PHA) heat seal layer, having a thickness of 9g/m², applied by aqueous dispersion coating or extrusion coating.

Alternatively, the PHA heat seal polymer can be blended (i.e. compounded) with a certain amount of hardwood cellulosic fibres, in order to provide higher content of cellulose in the overall structure, hence increasing the marine biodegradability properties.

In FIG. 2 is depicted a second embodiment of a paper-based barrier multilayer packaging structure 1 according to the invention.

In this second embodiment, the multilayer structure comprises in order, from its outer side towards its inner side (i.e. the inner side in contact with the packaged product):
a highly smooth paper layer 2 of grammage 62 g/m²,
a first organic coating layer 3 of PHA polymer which is optionally functionalized by a plasma activation treatment, and can also optionally be compounded with 30-70% weight of hardwood cellulosic fibres, said first organic polymer being applied as an aqueous solution in an amount of 3 g/m², then
an organic barrier layer 6 of microfibrillated or nanofibrillated cellulose polymer that is plasma activated for functionalization, is applied as a tie layer for bonding the first organic pre-metallization layer 3 to the outer side of the next inorganic layer described hereafter; this tie layer 6 being applied as an aqueous dispersion in an amount of 1 g/m²
then a vacuum-deposited inorganic (aluminium) layer 4 of thickness 40 nm is applied, that is followed by
a second organic layer 5 which fulfils the role of a second post-metallization layer, being composed of polycaprolactone (PCL) polymer applied as a post-metallization on the inner side of the inorganic layer 4, as an aqueous dispersion in an amount of 5 g/m².

The organic tie layer 6 can alternatively be composed of a polyglycolide polymer (PGA) instead of a micro/nanofibrillated cellulose, or a marine biodegradable polyvinylalcohol (PVOH).

As an alternative to aluminium in the inorganic layer, a metalloid can be applied, which is either SiOx or AlOx.

Like in the first embodiment, alternative polymers to PCL can be envisaged, provided that there resilience characteristics (tensile strength, elongation at break) correspond to the requirements set out for working the invention, i.e., polymers having tensile strength values above 30 MPa and elongation at break above 850%. Alternatively, this PCL layer can be replaced by a polyhydroxyalcanoate (PHA) or a protein-based layer such as casein.

The structures corresponding to the above-described embodiments fulfil the requirements for marine biodegradability of the material or a packaging made thereof, in standard conditions.

A preferred manufacturing process involves the following steps, in order:
first, a paper support material is covered through extrusion coating or dispersion coating by marine biodegradable first organic (pre-metallization) layer, then
this latter can be directly metallized (with or without a prior plasma activation), or alternatively, it can be covered by a second pass of a cellulose-based suspension or biopolymer dispersion, thus forming an additional barrier layer between the first organic layer and the next layer, then
the resulting structure is metallized, optionally after being subject to plasma activation, according to known plasma activation techniques, and then
the metallized structure is covered by an extrusion coated biopolymer layer, or directly covered by a biopolymer dispersion.

In all of the embodiments of the invention described above, the multilayer structure can comprise other additional and optional layers not described in full details therein. Such layers can comprise for instance a print layer on the outer surface of the paper layer, as well as optionally a protective layer that is deposited on the external side of the print layer, and therefore constitutes the outermost layer of the whole structure. Print and optional protective layers are not described in more detail because they are known technology to the skilled person.

1. A marine biodegradable and recyclable multi-layer metallized paper-based packaging material comprising, from its outer side to its inner side:
a paper layer having a grammage ranging from 30 to 120 g/m²,
at least one first organic layer comprising at least one polymer being marine biodegradable according to standards ISO 22403:2020 or its equivalent ASTM D6691:2017, said at least one polymer being selected within the list of: a polyhydroxyalcanoate (PHA), a microfibrillated or nanofibrillated cellulose, a polyglycolide (PGA), or a combination thereof, said at least one polymer being applied as a layer in an amount of 0.5 to 15 g/m², said biodegradable polymer having a melting temperature comprised between 160° C. and 200° C.,
a vacuum deposited or transfer-metallized inorganic layer, comprising a metal, a metalloid, or a combination thereof, said inorganic layer having a thickness ranging from between 1 and 100 nm, and at least one second organic layer comprising at least one polymer being marine biodegradable according to standards ISO 22403:2020 or its equivalent ASTM D6691:2017, said at least one polymer being selected within the list of: a polyhydroxyalcanoate (PHA), a polycaprolactone (PCL), a protein-based extrusion grade or dispersion, or a combination thereof, said at least one polymer being applied in an amount between 0.5and 30 g/m², said biodegradable polymer having a melting temperature comprised between 30° C. and 160° C.

2. The multi-layer metallized paper-based packaging material according to claim 1, wherein the biodegradable polymer of said second organic layer has a tensile strength above 30 MPa and elongation at break above 850%.

3. The multi-layer metallized paper-based packaging material according to claim 1, wherein at least one polymer of said first and/or second organic layer(s) is functionalized by grafting with maleic anhydride.

4. The multi-layer metallized paper-based packaging material according to claim 1, wherein at least one polymer of said first and/or second organic layer(s) is plasma activated.

5. The multi-layer metallized paper-based packaging material according to claim 1, wherein the polyhydroxyalcanoate (PHA) of said at least one second organic layer is compounded with hardwood cellulose fibres, such that said compound comprises at least 50% of cellulose fibres.

6. The multi-layer metallized paper-based packaging material according to claim 1, wherein the first organic layer further comprises a mineral filler selected within the list of: kaolin, calcium carbonate, talc, silica, wollastonite, clay, calcium sulfate fibers (also known as Franklin fiber), mica, glass beads, alumina trihydrate, and combinations thereof.

7. The multi-layer metallized paper-based packaging material according to claim 1, wherein the metal or metalloid inorganic layer is selected within the list of: aluminium, aluminium oxide (AlO_{X}), silicon oxide (SiO_{X}), or an alloy thereof.

8. The multi-layer metallized paper-based packaging material (1) according to claim 1, further comprising an organic barrier layer coated between the first organic layer and the inorganic layer, said tie layer comprising a polyvinylalcohol (PVOH) or a polyglycolide (PGA) polymer, in an amount in the range of 0.5-30 g/m².

9. The multi-layer metallized paper-based packaging material according to claim 8, wherein the organic layers and the organic barrier layer are applied either as an aqueous solution or dispersion, or by extrusion of an ultrathin layer having a thickness lower than 30 g/m².

10. The multi-layer metallized paper-based packaging material in accordance with claim 1, wherein the packaging material is recyclable.

11. The multi-layer metallized paper-based packaging material according to claim 1, wherein the packaging material has a Water Vapour Transmission Rate (WVTR) below 1 g/m²/day (measured at 23° C., 85% Relative Humidity) and/or an Oxygen Transmission Rate below 1 cm³/m²/day bar (measured at 23° C., 50% RH).

12. The multi-layer metallized paper-based packaging material according to claim 1, wherein the packaging material has a strain at break under in-plane tensile loading up to 4% in machine direction and up to 10% in the cross-machine direction of the paper.

13. A tridimensional closed packaging item made of a marine biodegradable multi-layer metallized paper-based packaging material according to claim 1, which is obtained by forming, filling with an edible product for human or animal consumption, and then sealing said packaging material.

14. Use of a marine biodegradable multi-layer metallized paper-based packaging material according to claim 1, for packaging an edible product for human or animal consumption.

15. A packaged edible product, comprising a marine biodegradable multi-layer metallized paper-based packaging material according to claim 1, filled with an edible product for food or animal consumption.

16. The multi-layer metallized paper-based packaging material according to claim 1, wherein the organic layers are applied either as an aqueous solution or dispersion, or by extrusion of an ultrathin layer having a thickness lower than 30 g/m².
